(19) United States
(12) Patent Application Publication
(10) Pub. No.: US 2009/0044668 A1
(43) Pub. Date: Feb. 19, 2009

(54) Torque device for use in tools

(76) Inventors: Shu-Sui Lin, Taichung (TW); Yi-Chun Tseng, Taichung (TW)

Correspondence Address: PRO-TECHTOR INTERNATIONAL SERVICES, 20775 NORADA CT., SARATOGA, CA, 95070, US

(21) Appl. No.: 11/893,521

(22) Filed: Aug. 16, 2007

(51) Int. Cl. B25B 23/147; B25G 3/12

(52) U.S. Cl. 81/478; 81/29

(57) ABSTRACT

A torque device for use in tools comprises a tubular member; a bit receiver axially received at the front end of the tubular member and its front end may couple with tools; a shank inserted at the rear end of the tubular member and including a resilient element fitted thereon, and including a receiving chamber formed at the rear end thereof for receiving a driving tool, and a selector mechanism defined between the shank and the bit receiver; a fitting sleeve fitted on the shank for biasing against the resilient element and including inner threads arranged on the inner wall thereof, between the fitting sleeve and the tubular member being provided with a guiding mechanism; an adjusting member fitted at the rear end of the shank including outer threads for screwing with the inner threads of the fitting sleeve, and between the adjusting member and the tubular member being fixed a confining mechanism.

### BACKGROUND OF THE INVENTION

1. Field of the Invention

The present invention relates to a torque device for use in tools that may prevent from the damage of the related components and may selectively couple with various types of driving tools.

2. Description of the Prior Arts

To accommodate different conditions and prevent the damage of the related components of tools, a ratchet device provided onto the tools is indispensable, especially in a specific torque fastening operation. Referring to FIGS. 1-3, a prior art driver tool comprises a handle 10 including a ratchet device 11 disposed at the front end thereof and having a ratchet seat 12, a sleeve member 13, and a cover member 14 defined therein. The ratchet seat 12, rear end of which is mounted at the front end of the handle 10, includes an axial bore 121 for the insertion of the sleeve member 13 arranged therein, and includes expandable and extractable engaging blocks secured thereon. By using the cover member 14, the ratchet seat 12 allows to be selectively switched, thereby controlling the rotating direction of the sleeve member 13. The sleeve member 13 includes teeth 131 arranged on the outer rim thereof for the engagement with the engaging blocks, and a shank includes a polygonal hole 132 attached therein for fitting a bit 15, such that as rotating the handle 10 to actuate the rotation of the ratchet seat 12, one of the engaging blocks urges the sleeve member 13 to rotate the bit 15, and as the handle 10 rotated in an opposite direction, the ratchet seat 12 is urged to rotate, and the engaging block may move inward along the teeth 131 of the sleeve member 13, thus forming an idle rotation during the screw unfastening operation However, such a prior art driver tool may not be provided with a ratchet device, causing an operational limitation.

The present invention has arisen to mitigate and/or obviate the afore-described disadvantages.

### SUMMARY OF THE INVENTION

The primary object of the present invention is to provide a torque device for use in tools that may prevent from the damage of the related components.

The secondary object of the present invention is to provide a torque device for use in tools that may selectively couple with various types of driving tools.

In accordance with one aspect of the present invention, there is provided a torque device for use in tools comprising a tubular member; a bit receiver axially received at the front end of the tubular member and its front end may couple with tools; a shank inserted at the rear end of the tubular member and including a resilient element fitted thereon, and including a receiving chamber formed at the rear end thereof for receiving a driving tool, and a selector mechanism defined between the shank and the bit receiver; a fitting sleeve fitted on the shank for biasing against the resilient element and including inner threads arranged on the inner wall thereof, a guiding mechanism provided between the fitting sleeve and the tubular member; an adjusting member fitted at the rear end of the shank including outer threads for screwing with the inner threads of the fitting sleeve, and a confining mechanism fixed between the adjusting member and the tubular member.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a prior art ratchet wrench;

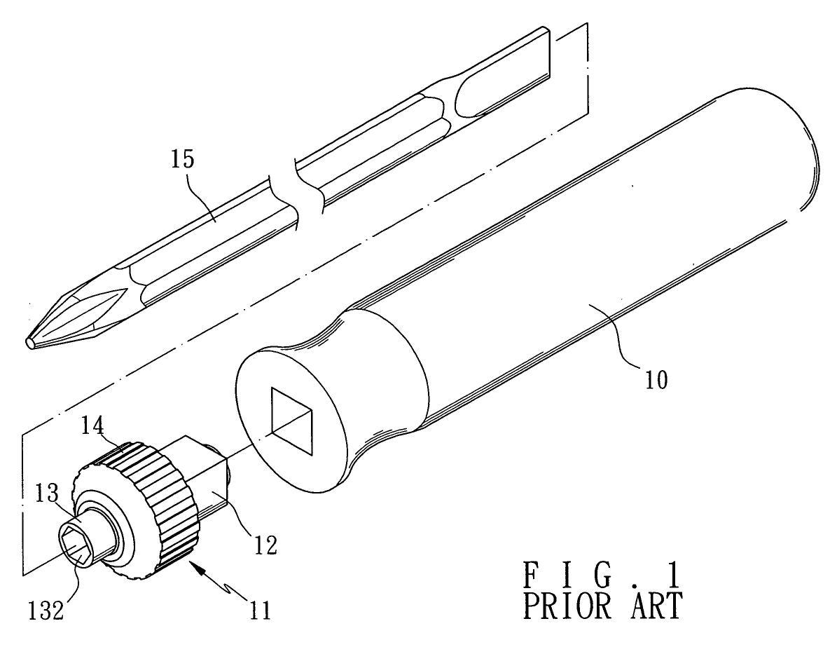

FIG. 2 is a perspective diagram illustrating the assembly of the prior art ratchet wrench;

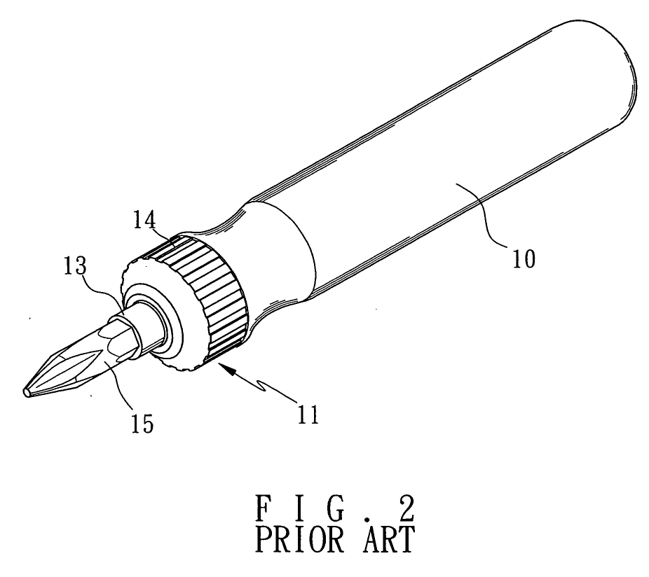

FIG. 3 is a cross sectional diagram illustrating the assembly of the prior art ratchet wrench;

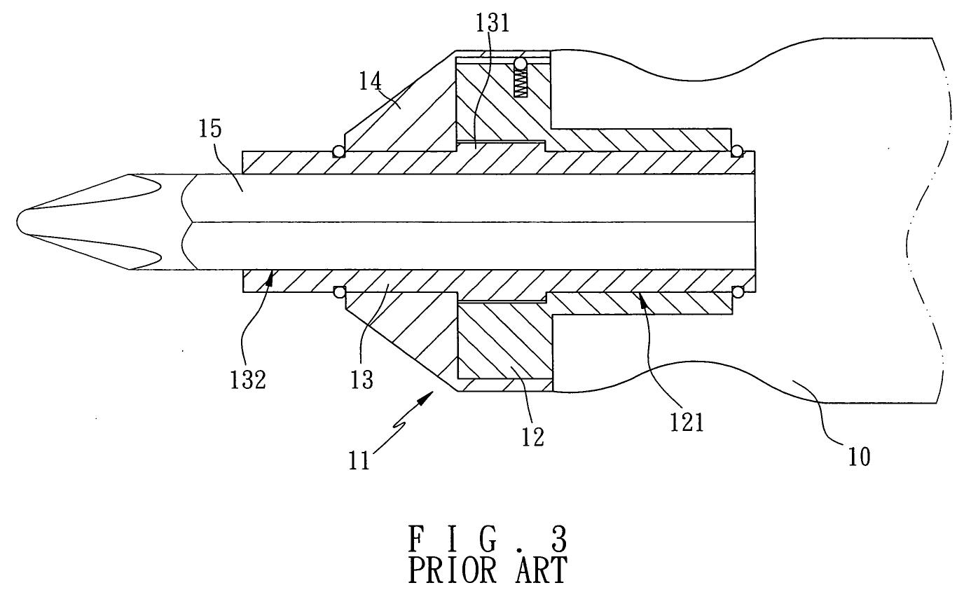

FIG. 4 is a perspective diagram illustrating the exploded components of a torque device for use in tools according to the present invention;

FIG. 5 is a perspective diagram illustrating the assembly of the torque device for use in tools according to the present invention;

FIG. 6 is a cross sectional diagram illustrating the assembly of the torque device for use in tools according to the present invention;

FIG. 7 is a cross sectional diagram illustrating the maximum torque of the torque device for use in tools according to the present invention being set;

FIG. 8 is an exploded diagram illustrating the torque device for use in tools according to the present invention being provided to receive a tool with a ratchet device;

FIG. 9 is an assembly diagram illustrating the torque device for use in tools according to the present invention being provided to receive the tool with a ratchet device;

FIG. 10 is a cross sectional diagram illustrating the torque device for use in tools according to the present invention being provided to receive the tool with a ratchet device;

FIG. 11 is a cross sectional diagram of the torque device for use in tools according to the present invention, taken along lines A-A of FIG. 10;

FIG. 12 is a cross sectional diagram illustrating the operation of the torque device for use in tools according to the present invention being provided to receive a tool with a ratchet device;

FIG. 13 is another cross sectional diagram illustrating the operation of the torque device for use in tools according to the present invention being provided to receive a tool with a ratchet device;

FIG. 14 is a perspective diagram illustrating the torque device for use in tools according to the present invention being provided to receive an electric tool.

### DETAILED DESCRIPTION OF THE PREFERRED EMBODIMENT

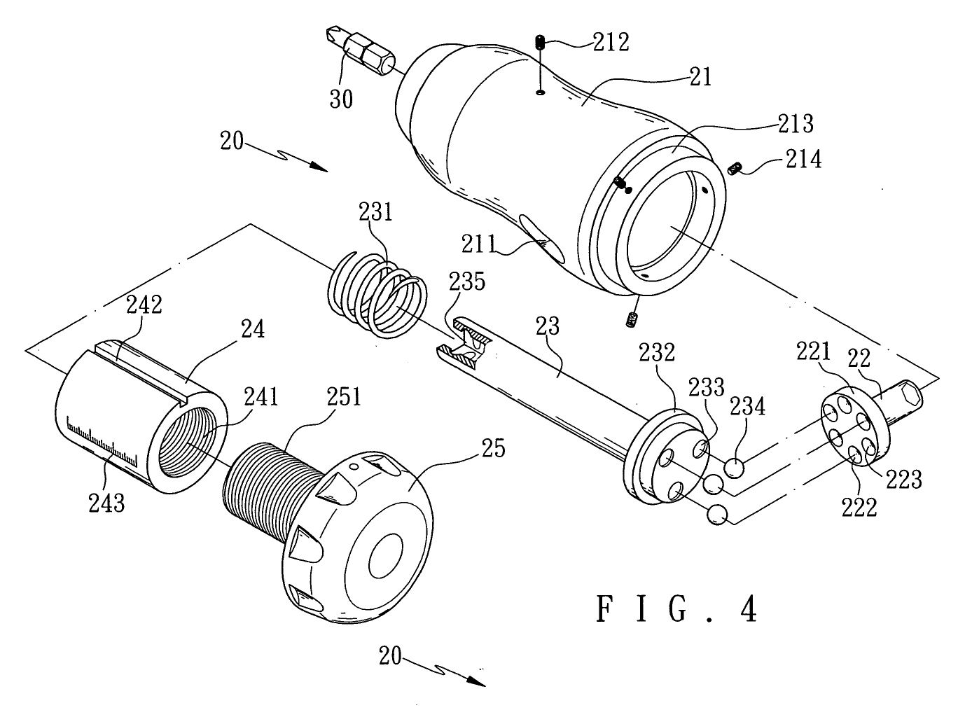

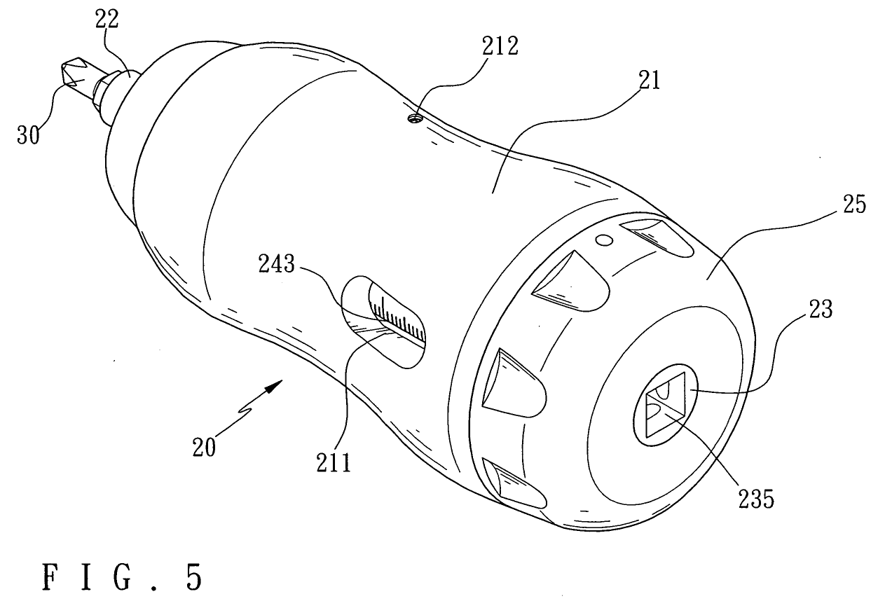

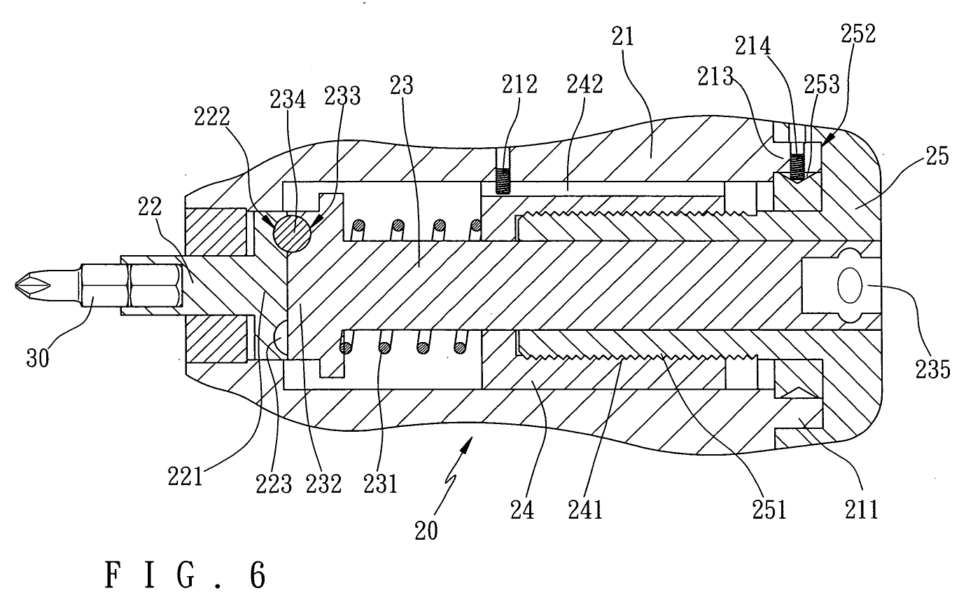

Referring to FIGS. 4-6, a torque device 20 for use in tools in accordance with the present invention comprises a tubular member 21 including a bit receiver 22 axially received at the front end thereof and having a polygonal bore formed therein for receiving a bit 30, and including a through slot 211 disposed on the external rim thereof, and including a shank 23 inserted therein and having a resilient element 231 fitted thereon. The resilient element 231 may be a spring. Additionally, a selector mechanism defined between the shank 23 and the bit receiver 22 for arresting the bit receiver 22 includes a driving disk 232 affixed at the front end of the shank 23, one side of the driving disk 232 abuts against the resilient element 231, yet another side of the driving disk 232 is provided with a plurality of dents 233 for receiving a number of balls 234 therein, each extending out of another side of the driving disk 232. The bit receiver 22 includes a transmitting disk 221 attached at the rear end thereof and having two retaining cavities 222, 223 in response to the balls 234 fixed at the end surface thereof, such that the shank 23 may engage with the transmitting disk 221 so as to urge the rotation of the bit 30. Besides, the shank 23 includes a polygonal receiving chamber 235 formed at the rear end thereof for receiving a driving tool, and includes a fitting sleeve 24, front end of which is biased against the resilient element 231, fitted thereon and having inner threads 241 arranged on the inner wall thereof. Also, between the fitting sleeve 24 and the tubular member 21 is provided with a guiding mechanism including a guide groove 242 secured on the outer periphery thereof, and on the outer rim of the tubular member 21 corresponding to the guide groove 242 is disposed a hole for screwing with a first bolt element 212. Furthermore, at a predetermined position of the fitting sleeve 24 in response to the through slot 211 is mounted a torque indicator 243 for displaying the torque value. An adjusting member 25 fitted at the rear end of the shank 23 includes outer threads 251 for screwing with the inner threads 241 of the fitting sleeve 24, and between the adjusting member 25 and the tubular member 21 is fixed a confining mechanism including a coupling portion 213 arranged at the rear end of the tubular member 21 and having a plurality of bores secured on the peripheral surface thereof for screwing with a number of second bolt elements 214. At a predetermined position of the adjusting member 25 corresponding to the through slot 211 is attached a recess 252 for receiving the coupling portion 213, and at another predetermined position thereof in response to the second bolt element 214 is affixed a cut 253, in which the second bolt element 214 is screwed so as to urge the forward and backward movement of the fitting sleeve 24 during rotating the adjusting member 25.

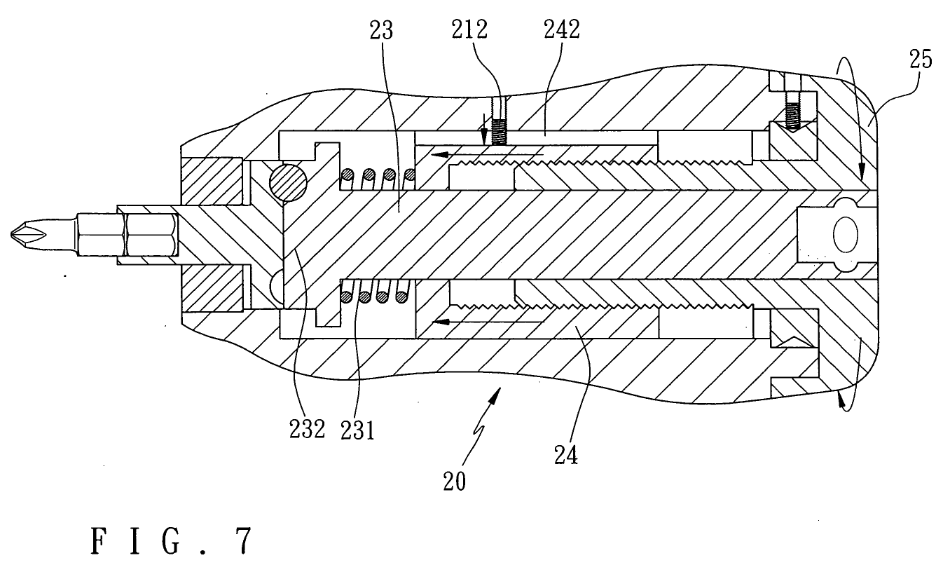

As shown in FIG. 7, in the fastening operation, a proper torque value is present, for example, as desiring to enhance the torque valve, the adjusting member 25 is turned for moving the fitting sleeve 24 forward, and then the front end of the fitting sleeve 24 contacts the resilient element 231 to push against the driving disk 232 so as to enhance the required torque valve of the selector mechanism, and then the first bolt element 212 is fitted to abut against the bottom the guide groove 242, thus positioning the fitting sleeve 24.

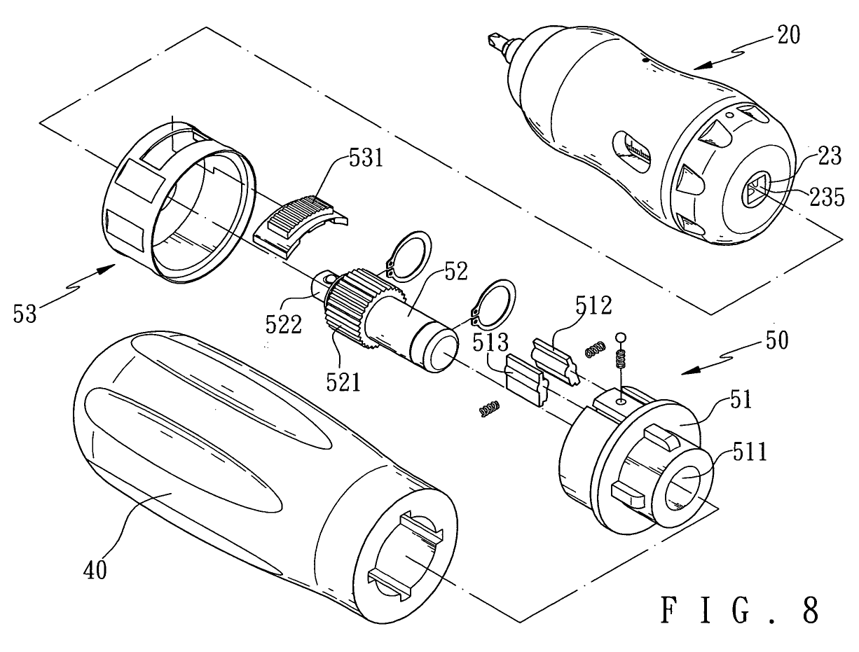

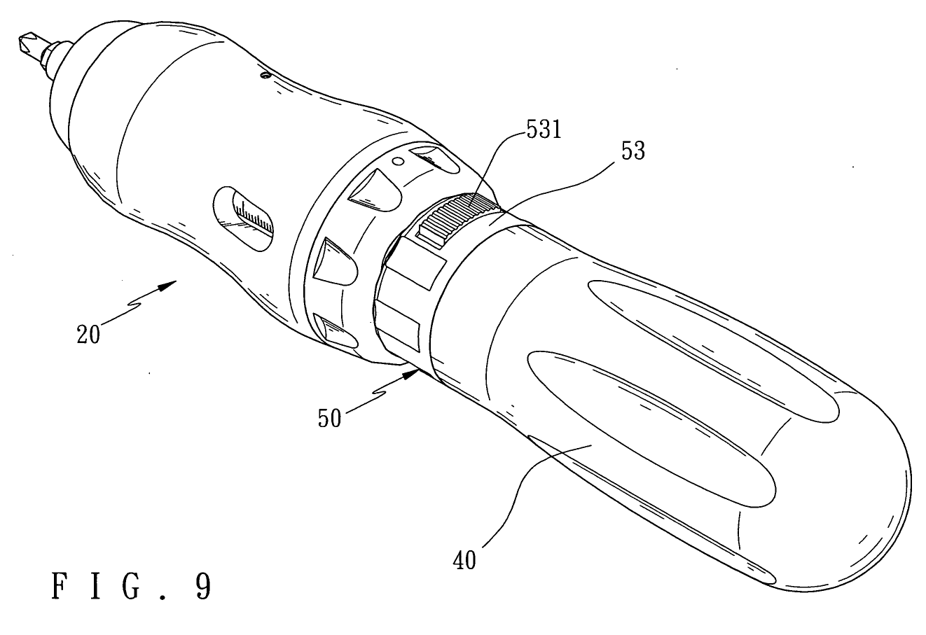

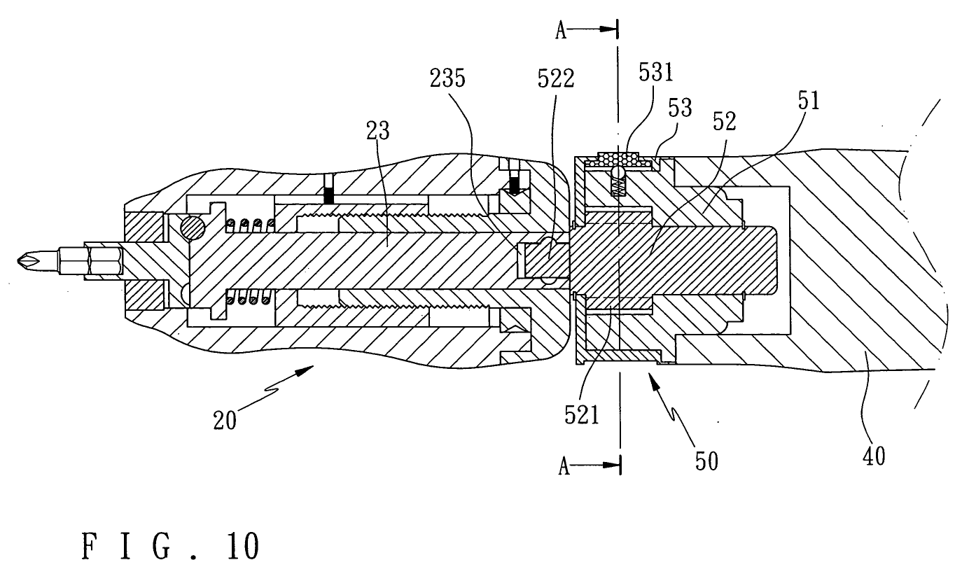

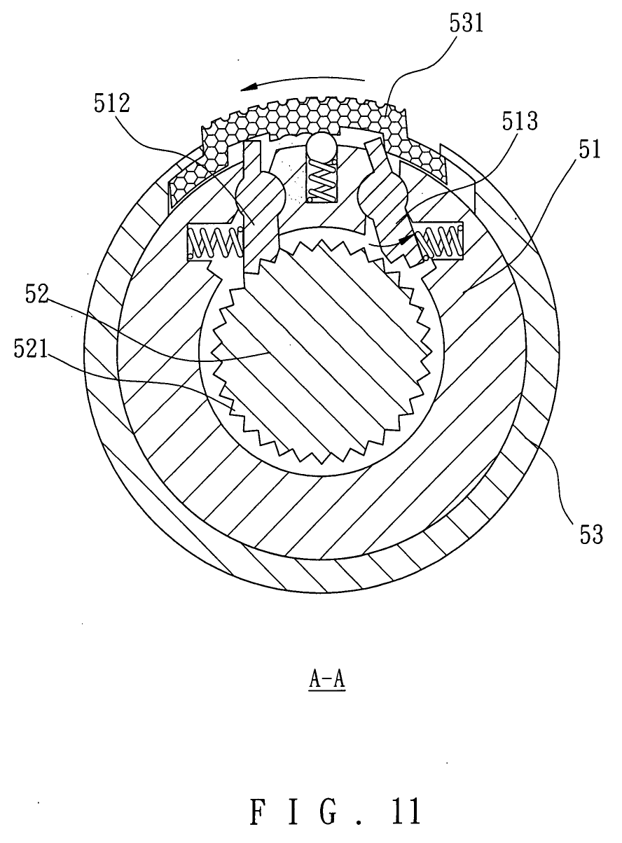

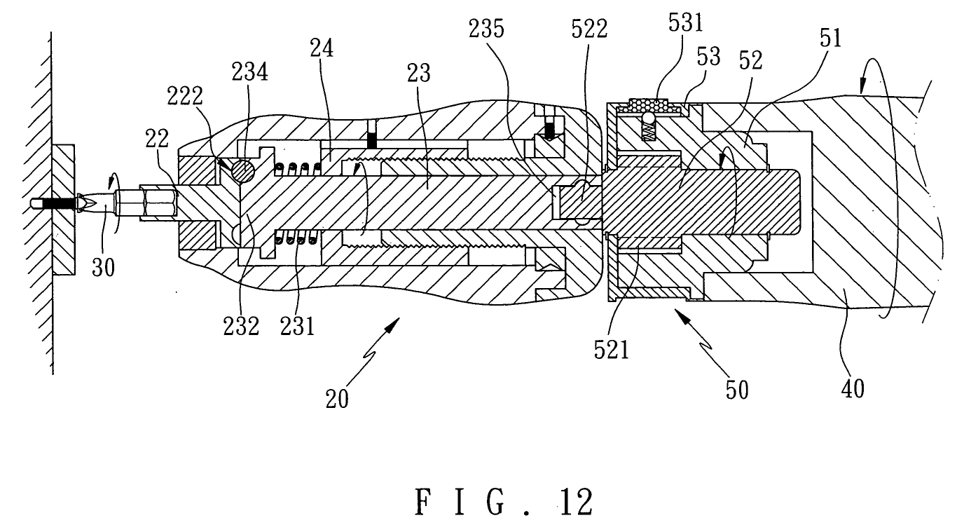

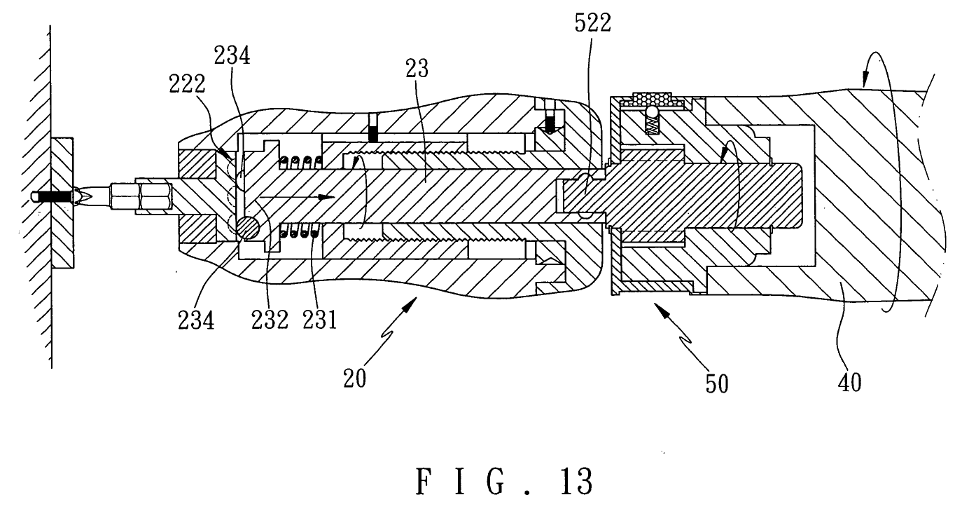

As illustrated in FIGS. 8-10, the torque device 20 is provide to receive a tool with a ratchet device by way of the receiving chamber 235 of the shank 23, wherein the tool includes a handle 40 having a ratchet device 50 disposed at the front end thereof. The ratchet device 50 includes a ratchet seat 51, an urging shaft 52, and a cover member 53 having a switch 531 affixed thereon. The ratchet seat 51, rear end of which is mounted at the front end of the handle 40, includes an axial bore 511 arranged therein for the insertion of the urging shaft 52, and includes movable arresting blocks 512, 513 secured thereon. By means of the switch 531 of the cover member 53, the rotating direction of the urging shaft 52 is controllable, and the urging shaft 52 includes teeth 521 for the engagement with the arresting blocks 512, 513 arranged on the peripheral surface thereon, and includes an actuation segment 522 for insertion into the receiving chamber 235 attached at the front end thereof, thus attaching the tool to the torque device 20. Referring to FIGS. 11 and 12, by turning the switch 531 of the ratchet device 50, the arresting block 513 disengages from the teeth 521 of the urging shaft 52 so as to rotate the handle 40, and by using the arresting block 512 and the actuation segment 522 of the urging shaft 52, the shank 23 is driven to rotate. Since the driving disk 232 of the shank 23 is pushed by the resilient element 231, the balls 234 of the driving disk 232 movably engage with the retaining cavity 222 of the bit receiver 22, hence the rotary torque of the shank 23 transmits to the bit receiver 22 for fastening screws by means of the bit 30. Referring further to FIG. 13, as obtaining the maximum torque value of the torque device 20, the counterforce forces the resilient element 231 not to bear the torque of the shank 23, accordingly as keep on rotating the handle 40, the balls 234 disengage from the retaining cavities 222 of the bit receiver 22 and push the shank 23 to move backward for stopping the transmission of the rotating torque of the shank 23, preventing from the damage of the related components.

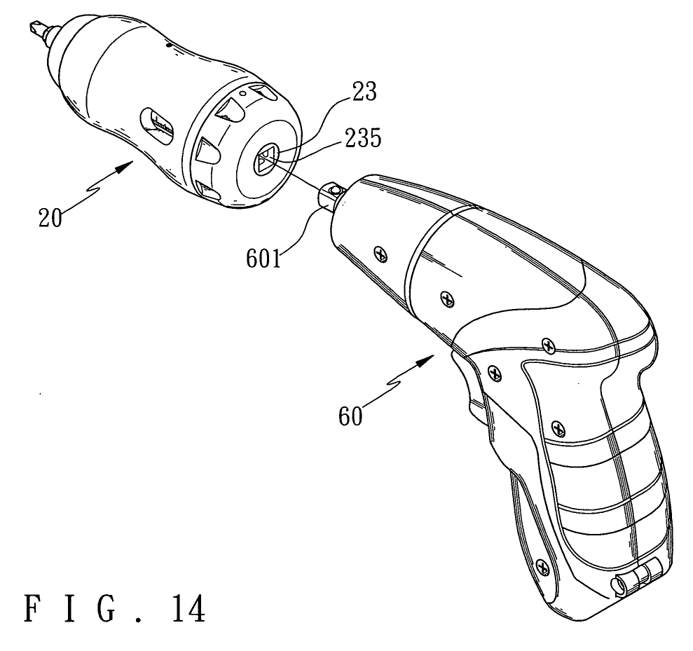

With reference to FIG. 14, the torque device 20 may further be provided to couple with an electric tool 60 for the fastening operation as well, wherein the electric tool 60 includes an acting portion 601 arranged at the input end thereof for the insertion into the receiving chamber 235 of the shank 23.

The invention is not limited to the above embodiment but various modifications thereof may be made. It will be understood by those skilled in the art that various changes in form and detail may made without departing from the scope and spirit of the present invention.

What is claimed is:

1. A torque device for use in tools comprising:
a tubular member;
a bit receiver axially received at the front end of said tubular member, and its said bit receiver may couple with tools;
a shank inserted at the rear end of said tubular member and including a resilient element fitted thereon, and including a receiving chamber formed at the rear end thereof for receiving a driving tool, and a selector mechanism defined between said shank and said bit receiver;
a fitting sleeve fitted on said shank for biasing against said resilient element and including inner threads arranged on the inner wall thereof, a guiding mechanism provided between said fitting sleeve and said tubular member;
an adjusting member fitted at the rear end of said shank including outer threads for screwing with said inner threads of said fitting sleeve, and between said adjusting member and said tubular member being fixed a confining mechanism.

2. The torque device for use in tools as claimed in claim 1, wherein said tubular member includes a through slot disposed on the external rim thereof.

3. The torque device for use in tools as claimed in claim 1, wherein said bit receiver includes a polygonal bore formed at the front end thereof for receiving a bit.

4. The torque device for use in tools as claimed in claim 1, wherein a selector mechanism between said shank and said bit receiver includes a driving disk affixed at the front end of said shank, one side of said driving disk abuts against said resilient element, yet another side of said driving disk is provided with a plurality of dents for receiving a number of balls therein, each extending out of another side of said driving disk, said bit receiver includes a transmitting disk attached at the rear end thereof and having two retaining cavities in response to the balls fixed at the end surface thereof.

5. The torque device for use in tools as claimed in claim 1, wherein said receiving chamber is constructed in the form of a polygon.

6. The torque device for use in tools as claimed in claim 1, wherein said driving tool disposed at the rear end of said shank is a tool with a ratchet device.

7. The torque device for use in tools as claimed in claim 6, wherein said ratchet device includes a ratchet seat, an urging shaft, and a cover member having a switch affixed thereon. The ratchet seat, rear end of which is mounted at the front end of the handle, includes an axial bore arranged therein for the insertion of said urging shaft, and includes movable arresting blocks secured thereon. By means of said switch of said cover member, the rotating direction of said urging shaft is controllable, and said urging shaft includes teeth for the engagement with said arresting blocks arranged on the peripheral surface thereon, and includes an actuation segment for insertion into said receiving chamber attached at the front end thereof.

8. The torque device for use in tools as claimed in claim 1, wherein said driving tool may be an electric tool including an acting portion arranged at the input end thereof for the insertion into said receiving chamber of said shank.

9. The torque device for use in tools as claimed in claim 1, wherein at a predetermined position of said fitting sleeve in response to said through slot is mounted a torque indicator for displaying the torque value.

10. The torque device for use in tools as claimed in claim 1, wherein said guiding mechanism between said fitting sleeve and said tubular member includes a guide groove secured on the outer periphery thereof, and on the outer rim of said tubular member corresponding to said guide groove is disposed a hole for screwing with a first bolt element.

11. The torque device for use in tools as claimed in claim 1, wherein said confining mechanism between said adjusting member and said tubular member includes a coupling portion arranged at the rear end of said tubular member and having a plurality of bores secured on the peripheral surface thereof for screwing with a number of second bolt elements. At a predetermined position of said adjusting member corresponding to said through slot is attached a recess for receiving said coupling portion, and at another predetermined position thereof in response to said second bolt element is affixed a cut, in which said second bolt element is screwed so as to urge the forward and backward movement of said fitting sleeve during rotating said adjusting member.

12. A torque device for use in tools comprising:
a tubular member;
a bit receiver axially received at the front end of said tubular member, and the front end of said bit receiver may couple with tools;
a shank inserted at the rear end of said tubular member and including a resilient element fitted thereon, and including a receiving chamber formed at the rear end thereof, and a selector mechanism defined between said shank and said bit receiver;
a fitting sleeve fitted on said shank for biasing against said resilient element and including inner threads arranged on the inner wall thereof, between said fitting sleeve and said tubular member being provided with a guiding mechanism;
an adjusting member fitted at the rear end of said shank including outer threads for screwing with said inner threads of said fitting sleeve, and between said adjusting member and said tubular member being fixed a confining mechanism;
a driving tool including a handle having a ratchet device disposed at the front end thereof, the front end of an urging shaft of said ratchet device may be received at said receiving chamber of said shank.

13. The torque device for use in tools as claimed in claim 12, wherein said tubular member includes a through slot disposed on the external rim thereof.

14. The torque device for use in tools as claimed in claim 12, wherein said bit receiver includes a polygonal bore formed at the front end thereof for receiving a bit.

15. The torque device for use in tools as claimed in claim 12, wherein a selector mechanism between said shank and said bit receiver includes a driving disk affixed at the front end of said shank, one side of said driving disk abuts against said resilient element, yet another side of said driving disk is provided with a plurality of dents for receiving a number of balls therein, each extending out of another side of said driving disk, said bit receiver includes a transmitting disk attached at the rear end thereof and having two retaining cavities in response to the balls fixed at the end surface thereof.

16. The torque device for use in tools as claimed in claim 12, wherein said receiving chamber is constructed in the form of a polygon.

17. The torque device for use in tools as claimed in claim 12, wherein said ratchet device includes a ratchet seat, an urging shaft, and a cover member having a switch affixed thereon. The ratchet seat, rear end of which is mounted at the front end of the handle, includes an axial bore arranged therein for the insertion of said urging shaft, and includes movable arresting blocks secured thereon. By means of said switch of said cover member, the rotating direction of said urging shaft is controllable, and said urging shaft includes teeth for the engagement with said arresting blocks arranged on the peripheral surface thereon, and includes an actuation segment for insertion into said receiving chamber attached at the front end thereof.

18. The torque device for use in tools as claimed in claim 12, wherein at a predetermined position of said fitting sleeve in response to said through slot is mounted a torque indicator for displaying the torque value.

19. The torque device for use in tools as claimed in claim 12, wherein said guiding mechanism between said fitting sleeve and said tubular member includes a guide groove secured on the outer periphery thereof, and on the outer rim of said tubular member corresponding to said guide groove is disposed a hole for screwing with a first bolt element.

20. The torque device for use in tools as claimed in claim 12, wherein said confining mechanism between said adjusting member and said tubular member includes a coupling portion arranged at the rear end of said tubular member and having a plurality of bores secured on the peripheral surface thereof for screwing with a number of second bolt elements. At a predetermined position of said adjusting member corresponding to said through slot is attached a recess for receiving said coupling portion, and at another predetermined position thereof in response to said second bolt element is affixed a cut, in which said second bolt element is screwed so as to urge the forward and backward movement of said fitting sleeve during rotating said adjusting member.
